(19) United States
(12) Patent Application Publication
(10) Pub. No.: US 2018/0357036 A1
(43) Pub. Date: Dec. 13, 2018

(54) DISPLAY SYSTEM, DISPLAY DEVICE, AND METHOD OF CONTROLLING DISPLAY SYSTEM

(71) Applicant: SEIKO EPSON CORPORATION, Tokyo (JP)

(72) Inventor: Kenichiro TOMITA, Matsumoto-Shi (JP)

(73) Assignee: SEIKO EPSON CORPORATION, Tokyo (JP)

(21) Appl. No.: 15/994,095

(22) Filed: May 31, 2018

(30) Foreign Application Priority Data
Jun. 13, 2017 (JP) 2017-115811

(51) Int. Cl. G06F 3/14

(52) U.S. Cl. CPC G06F 3/1454

(57) ABSTRACT

A display system includes a projector adapted to display a conference-use image, a storage section adapted to store a relative position between a virtual viewing position set in advance to the projector and the projector, a virtual image generation section adapted to generate the virtual image data corresponding to an image obtained by viewing the conference-use image displayed by the projector from the virtual viewing position, a transmitting device adapted to transmit the virtual image data generated by the virtual image generation section, and a terminal device adapted to display the virtual image based on the virtual image data transmitted by the transmitting device.

### BACKGROUND

### 1. Technical Field

The present invention relates to a display system, a display device, and a method of controlling the display system.

### 2. Related Art

In the past, there has been known a system for performing an electronic conference using display devices and cameras (see, e.g., JP-A-2010-28299 (Document 1)). In the configuration of Document 1, by dividing a taken image into an image of one participant of a conference and an image of the other participant of the conference and transmitting the images to the devices of the respective counterparts of the conference using the cameras and the display devices, the participants in sites in remote locations have the conference.

In the related art system described above, since there is adopted a configuration in which the participants in other sites are displayed by the display device, there is a problem that it is difficult to produce feeling of presence.

### SUMMARY

An advantage of some aspects of the invention is to provide a system capable of making the participants of a conference have the feeling of presence.

A display system according to an aspect of the invention includes a first display device adapted to display an original image, a storage section adapted to store a relative position between a virtual viewing position set in advance to the first display device and the first display device, a virtual image generation section adapted to generate virtual image data corresponding to an image obtained by viewing the original image displayed by the first display device from the virtual viewing position, a transmitting device adapted to transmit the virtual image data generated by the virtual image generation section, and a second display device adapted to display the virtual image based on the virtual image data transmitted by the transmitting device.

According to the aspect of the invention, the image displayed in the second display device corresponds to the image obtained by viewing the original image displayed by the first display device from the virtual viewing position. Therefore, it becomes possible for the user present in the place where the first display device cannot directly be viewed or the place where it is difficult to view the first display device to have an experience as if the user viewed the first display device from the virtual viewing position using the second display device. Therefore, in the case of holding a conference in which the plurality of users participates, the experience rich in the feeling of presence can be provided regardless of whether the location of the user is the place where the first display device can directly be viewed, or the place where it is difficult to view the first display device.

A display system according to another aspect of the invention includes a first display device installed in a first site, and adapted to display a conference-use image, a storage section adapted to store a virtual viewing position set in advance to the first display device in the first site, a virtual image generation section adapted to generate virtual image data corresponding to an image obtained by viewing the conference-use image displayed by the first display device from the virtual viewing position, a transmitting device adapted to transmit the virtual image data generated by the virtual image generation section, and a second display device used in a second site, and adapted to display the virtual image based on the virtual image data transmitted by the transmitting device.

According to the aspect of the invention, the image displayed in the second display device corresponds to the image obtained by viewing the conference-use image displayed by the first display device from the virtual viewing position. Therefore, it becomes possible for the user present in a place other than the first site to have an experience as if the user viewed the first display device in the first site using the second display device. Therefore, in the case of holding a conference in which the plurality of users participates, the experience rich in the feeling of presence can be provided to either of the user present in the first site where the first display device is installed and the user not present in the first site.

The aspect of the invention may be configured to include an object disposed at a position corresponding to the virtual viewing position.

According to the aspect of the invention with this configuration, it is possible to make the user present in the position where the first display device can be viewed feel the presence of the user using the second display device, and it is possible to provide the experience rich in the feeling of presence to a larger number of users.

The aspect of the invention may be configured such that the transmitting device is provided with a detection section adapted to detect a position of the object, and the storage section stores the position of the object detected by the detection section as the virtual viewing position.

According to the aspect of the invention with this configuration, since the position of the object is stored as the virtual viewing position, the virtual viewing position corresponding to the position of the object can easily be set.

The aspect of the invention may be configured such that, in a case in which the position of the object is designated, the transmitting device stores the position of the object designated in the storage section as the virtual viewing position.

According to the aspect of the invention with this configuration, in the case in which the position of the object is designated, the virtual viewing position corresponding to the position of the object thus designated can easily be set.

The aspect of the invention may be configured such that the virtual image generation section generates the virtual image data based on a relative position between the first display device and the virtual viewing position, and conference-use image data representing the conference-use image.

According to the aspect of the invention with this configuration, it is possible to generate the virtual image data accurately corresponding to the image obtained by viewing the conference-use image from the virtual viewing position.

The above aspect of the invention may be configured such that the transmitting device includes a transmitting section adapted to transmit the virtual taken image data generated by the virtual image generation section to the second display device, and an imaging section adapted to image at least a part of a viewing space where an image displayed by the first display device can be viewed, and the virtual image generation section generates virtual taken image data corresponding to an image obtained by viewing the viewing space from the virtual viewing position.

According to the aspect of the invention with this configuration, it becomes possible to display the image corresponding to the sight obtained by viewing the viewing space from the virtual viewing position by the second display device. Therefore, it is possible to provide the viewing experience rich in the feeling of presence as if the user were present in the viewing space to the user located in the position where the first display device cannot be viewed or it is difficult to view the first display device.

The aspect of the invention may be configured such that, in a case in which a virtual sight line direction based on the virtual viewing position is designated, the virtual image generation section generates the virtual taken image data corresponding to a case of viewing the virtual sight line direction from the virtual viewing position.

According to the aspect of the invention with this configuration, it is possible to provide the viewing experience rich in the feeling of presence as if the user viewed the viewing space and the display image of the first display device from the virtual viewing position to the user located in the position where the first display device cannot be viewed or it is difficult to view the first display device.

The aspect of the invention may be configured such that the second display device is provided with a second device transmitting section adapted to transmit virtual sight line data adapted to designate the virtual sight line direction, the transmitting device is provided with a reception section adapted to receive the virtual sight line data transmitted from the second display device, and the virtual image generation section generates the virtual taken image data based on the virtual sight line data received by the reception section.

According to the aspect of the invention with this configuration, the virtual sight line direction can be designated in accordance with the sight line or the operation of the user present in the place where the second display device is used or the vicinity of the place. Therefore, it is possible to provide the viewing experience richer in feeling of presence to the user located in the position where the first display device cannot be viewed or it is difficult to view the first display device.

The aspect of the invention may be configured such that the transmitting device is the first display device.

According to the aspect of the invention with this configuration, by the first display device transmitting the virtual image data, it is possible to simplify the configuration of the system.

Another aspect of the invention there is directed to a display device including a display section adapted to display an original image based on original image data, the display device including a storage section adapted to store a relative position between a virtual viewing position set in advance to the display device and the display device, a virtual image generation section adapted to generate virtual image data corresponding to an image obtained by viewing an image displayed by the display section from the virtual viewing position, and a transmitting section adapted to transmit the virtual image data generated by the virtual image generation section to an external display device.

According to the aspect of the invention, it is possible for the external display device to perform display based on the virtual image data corresponding to the image obtained by viewing the original image displayed by the display device from the virtual viewing position. Therefore, it becomes possible for the user present in the place where the display device according to the aspect of the invention cannot directly be viewed or the place where it is difficult to view the display device to have experience as if the user viewed the original image from the virtual viewing position using the external display device. Therefore, in the case of holding a conference in which the plurality of users participates, the experience rich in the feeling of presence can be provided regardless of whether the location of the user is the place where the original image can directly be viewed, or the place where it is difficult to view the original image.

Another aspect of the invention is directed to a method of controlling a display system provided with a first display device adapted to display an original image, and a second display device, the method including the steps of generating virtual image data corresponding to an image obtained by viewing the original image displayed by the first display device from the virtual viewing position based on a relative position between a virtual viewing position set in advance to the first display device and the first display device, transmitting the virtual image data generated to the second display device, and displaying, by the second display device, the virtual image based on the virtual image data.

According to the aspect of the invention, the image displayed in the second display device corresponds to the image obtained by viewing the original image displayed by the first display device from the virtual viewing position. Therefore, it becomes possible for the user present in the place where the first display device cannot directly be viewed or the place where it is difficult to view the first display device to have an experience as if the user viewed the first display device from the virtual viewing position using the second display device. Therefore, in the case of holding a conference in which the plurality of users participates, the experience rich in feeling of presence can be provided regardless of whether the location of the user is the place where the first display device can directly be viewed, or the place where it is difficult to view the first display device.

The invention can be implemented in a variety of forms other than the display system, the display device, and the method of controlling the display system described above. For example, the invention can be implemented as a program executed by a computer (or a processor) for executing the control method described above. Further, the invention can be implemented as a recording medium storing the program described above, a server for delivering the program, a transmission medium for transmitting the program described above, and a data signal including the computer program described above and embodied in a carrier wave.

### BRIEF DESCRIPTION OF THE DRAWINGS

The invention will be described with reference to the accompanying drawings, wherein like numbers reference like elements.

FIG. 1 is a schematic configuration diagram of a display system according to a first embodiment of the invention.

FIG. 2 is a block diagram of a projector.

FIG. 3 is a block diagram of a projector.

FIG. 4 is a block diagram of a terminal device.

FIG. 5 is a flowchart showing an action of the display system.

FIG. 6 is a flowchart showing an action of the display system.

FIG. 7 is a schematic configuration diagram of a display system according to a second embodiment of the invention.

FIG. 8 is a flowchart showing an action of the display system.

### DESCRIPTION OF EXEMPLARY EMBODIMENTS

### First Embodiment

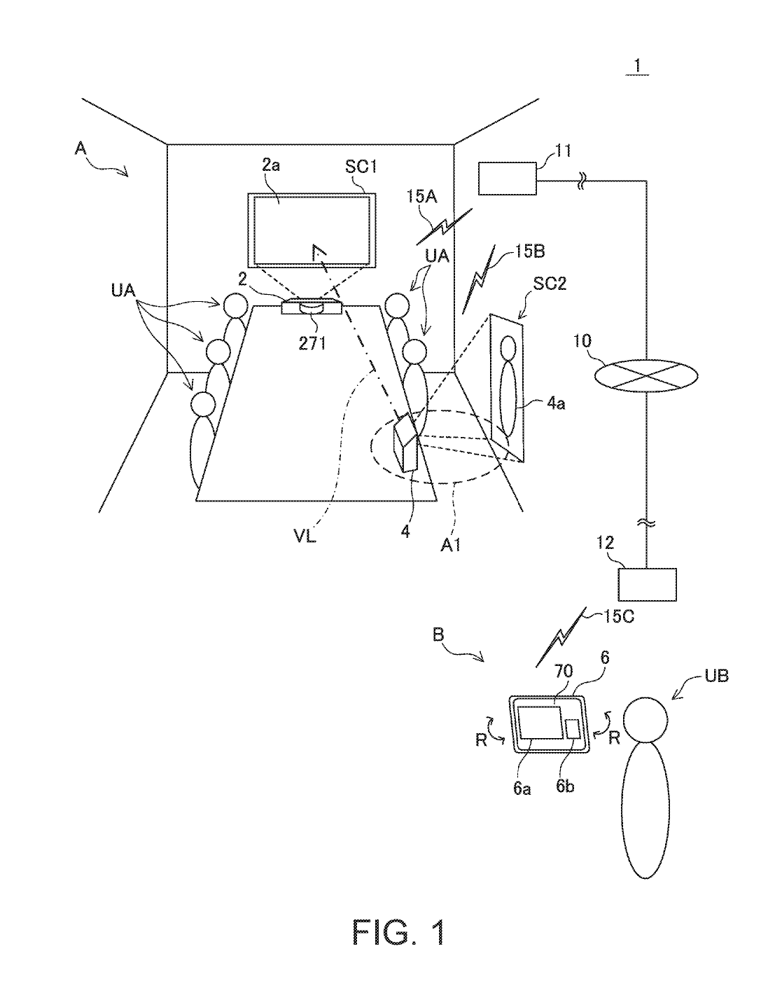

FIG. 1 is a schematic configuration diagram of a display system 1 according to an embodiment to which the invention is applied.

The display system 1 is a system provided with a plurality of display devices, and includes, in the present embodiment, a projector 2 (a first display device, a display device, a transmitting device), and a terminal device 6 (a second display device, an external display device). Further, the display system 1 according to the present embodiment is provided with a projector 4.

In the present embodiment, as a configuration in which the display system 1 is used, the projector 2 and the terminal device 6 are disposed in two use locations A, B separately from each other. The projector 2 is fixed to the ceiling or the wall of a room as the use location A, or mounted on a desk or a dedicated installation stand. It is sufficient for the terminal device 6 to be a display device available in the use location B such as a light-weight display device of a portable type or a mobile type. Specifically, a notebook type computer, a tablet type computer, a smartphone, a cellular phone, or the like can be used as the terminal device 6.

The number of the projector 2 installed in the use location A is arbitrary, and it is also possible to display a plurality of images by the plurality of projectors and other display devices so that the participant UA can visually recognize the plurality of images. Further, for example, it is also possible to use a display device using a liquid crystal display panel or an organic EL display panel instead of the projector 2.

The same applies to the device used by the participant UB, and it is also possible to use the plurality of terminal devices 6 in the use location B. Further, the number of the participants UB using the terminal device 6 can also be two or more. For example, it is also possible for a participant different from the participant UB to participate the conference using substantially the same device as the terminal device 6 in the use location B, or a third use location other than the use location A or the use location B.

At least one participant UA is present in the use location A, and the use location B is a place where the participant UB is present. The use location A is a place where the conference using the projector 2 is held, and it is possible for the participant UA present in the use location A to visually recognize a conference-use image 2a (an original image) projected by the projector 2. The use location B is a place where the conference-use image 2a cannot visually be recognized, and is, for example, a remote location distant from the use location A. The participant UB remotely participates in the conference held in the use location A from the use location B using the terminal device 6.

The use location A corresponds to a first site, the use location B corresponds to a second site, and the space where the conference-use image 2a can visually be recognized in the use location A corresponds to a viewing space.

As shown in FIG. 1, the projector 2 is a display device to project (display) an image on a screen SC1 in the use location A. In FIG. 1, as an example of the projection image of the projector 2, there is projected the conference-use image 2a which is a material for the conference. The conference-use image 2a can be a still image, or can also be a moving image, and can also be accompanied by a sound. The screen SC1 is only required to be a surface on which the image light can be projected in the use location A, and can be a screen like a curtain, or can also be a wall surface, a ceiling surface or a whiteboard, and whether or not the screen SC1 is a plane is no object.

The projector 2 has a camera 271 described later. The imaging direction and the field angle of the camera 271 are set so that at least a part of the use location A can be imaged. Due to the camera 271, it is possible for the projector 2 to image the participant UA present in the use location A.

In the use location A, there is installed the projector 4. The projector 4 can be a portable device which can easily be moved, or can also be what is fixed on a desk, the wall surface, the ceiling surface and so on in the use location A.

The projector 4 is disposed at the position where the participant participates in the use location A. In other words, imitating one participant, the projector 4 is located in the use location A similarly to the participant UA. The projector 4 is a pseudo participant disposed in the use location A instead of the participant UB actually not present in the use location A, and, in other words, represents the participant UB.

In the present embodiment, assuming the case in which one participant is absent from the use location A, one projector 4 alone is installed in the user location A. In the case in which two or more participants are absent from the use location A, it is possible to install the corresponding number of projectors 4 to the number of the participants absent from the use location A, or it is also possible to adopt a configuration in which one projector 4 represents two or more participants.

The projector 4 has a function of making the participants UA present in the use location A visually recognize the presence of the participant UB, and corresponds to an object of the invention. In the present embodiment, the projector 4 projects (displays) a user image 4a as the image of the participant UB on the screen SC2 in the use location A. The object representing the participant UB is only required to be what can be visually recognized by the participant UA.

The projector 4 shown in FIG. 1 projects the user image 4a on the screen SC2, and the user image 4a represents the participant UB. It should be noted that the screen SC2 is only required to be a surface on which the image light can be projected in the use location A, and can be a screen like a curtain, or can also be the wall surface, the ceiling surface or the whiteboard, and whether or not the screen SC2 is a plane is no object.

It is also possible to use a device for displaying an image such as a television system or a display device instead of the projector 4, and in this case, it is possible to assume the image displayed as the object representing the participant UB. Further, the object can be a drawing, an illustration, a sticker, a photograph, or the like suspended, attached, installed, or drawn on the wall surface and a desk of the room constituting the use location A, or can also be what is put on a desk installed in the use location A.

In the use location A, the position where the object is installed is a virtual position where the participant UB participates in the conference in the use location A, and this position is called a virtual viewing position A1. The virtual viewing position A1 is a position set virtually, and a configuration in which the participant UA can visually recognize the virtual viewing position A1 itself is not required. The virtual viewing position A1 can be an area having a predetermined area or volume as shown in FIG. 1, or can also be a specific point. In the case in which the virtual viewing position A1 is an area, the virtual viewing position A1 can also be expressed by the center of the area or a position to be a reference of the area. The virtual viewing position A1 can be determined by a preliminary setting as described later, or the projector 2 recognizes the place where the projector 4 is installed to determine the place as the virtual viewing position A1. The virtual viewing position A1 is set as a relative position to the projector 2. The configuration of the expression of the virtual viewing position A1 is arbitrary, and it is possible to express the virtual viewing position A1 based on the position of the projector 2, or it is also possible to express the virtual viewing position A1 as the position to the reference position such as the wall surface, the floor surface or the ceiling surface set in the use location A.

Further, a sight line direction in the case of viewing (visually recognizing) the conference-use image 2a displayed by the projector 2 from the virtual viewing position A1 is defined as a virtual sight line direction VL. The virtual sight line direction VL is information virtually representing the direction in the case of viewing the conference-use image 2a or the screen SC1 from the virtual viewing position A1, and the configuration in which the participant UA can visually recognize the virtual sight line direction VL itself is not required. The virtual sight line direction VL can be information representing only the direction, or can also be information representing the direction and the distance.

The virtual sight line direction VL can be obtained by a reference position between the virtual viewing position A1 and the projector 2, but it is also possible for the virtual sight line direction VL to be designated or set separately from the virtual viewing position A1. For example, it is possible for the projector 2 to obtain the virtual sight line direction VL based on the virtual viewing position A1 and the projection direction of the projector 2. Further, it is also possible for the virtual sight line direction VL to be designated by, for example, the data transmitted by the terminal device 6. These examples will be described later in detail.

It should be noted that it is also possible to define the position of the user image 4a displayed by the projector 4 as the virtual viewing position A1, and in this case, the virtual sight line direction VL corresponds to the sight line direction of the case of viewing the conference-use image 2a from the position of the user image 4a.

The projector 2 constituting the display system 1 and the terminal device 6 are connected to each other so as to be able to communicate with each other. For example, the projector 2 is connected to a communication device 11 installed in the use location A or the vicinity of the use location A with a communication link 15A, and performs wireless communication due to the communication link 15A. Further, the terminal device 6 is connected to a communication device 12 installed in the use location B or the vicinity of the use location B with a communication link 15C, and performs wireless communication via the communication link 15C. The communication device 11 and the communication device 12 are connected to each other via the communication network 10. The communication network 10 can be a wide area network including an exclusive line, a public network, a cellular phone network, and so on, or can also be a local network installed in a building or a facility.

Further, in the present embodiment, there is shown an example of using the projector 4 for projecting the user image 4a as an object. The projector 4 is connected to the communication device 11 with a communication link 15B. Therefore, the projector 4 and the projector 2 are capable of communicating with each other via the communication device 11.

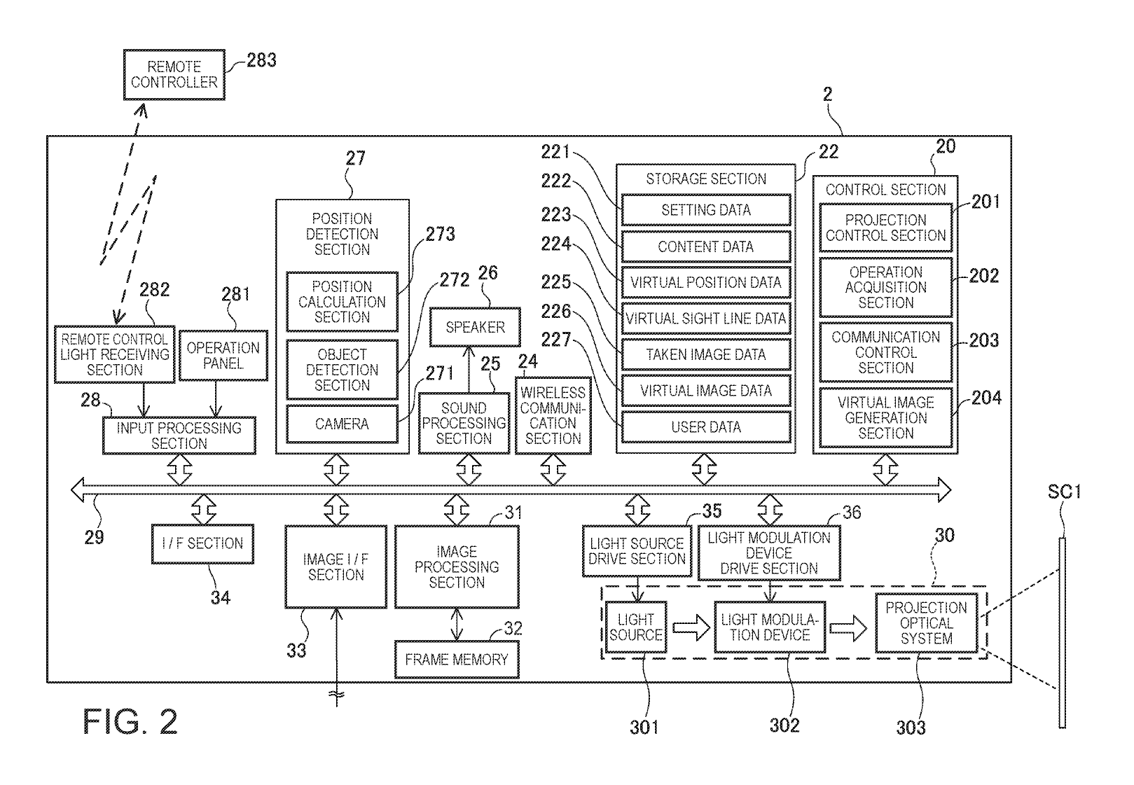

FIG. 2 is a block diagram of the projector 2.

The projector 2 is provided with a control section 20, a storage section 22, a wireless communication section 24, a sound processing section 25, a position detection section 27, and an input processing section 28. Further, the projector 2 is provided with a projection section 30, an image processing section 31, an image I/F (interface) section 33, and an I/F section 34. These sections are connected to each other via a bus 29 so as to communicate with each other. Further, as described later, a speaker 26 is connected to the sound processing section 25, and an operation panel 281 and a remote control light receiving section 282 are connected to the input processing section 28. Further, a frame memory 32 is connected to the image processing section 31.

The projector 2 obtains image data from an image source, and then projects an image based on the image data thus obtained using the projection section 30 due to the control by the control section 20. The function of the control section 20 and a variety of types of data stored by the storage section 22 will be described later.

The image source of the projector 2 can be selected from the image data input to the image I/F section 33, and the image data stored in the storage section 22. The storage section 22 stores contents data 222 (original image data) described later as the data which can be the image source.

It is possible to connect an image supply device (not shown) for supplying the image data to the projector 2 as the image source. As the image supply device, it is possible to use, for example, a notebook personal computer (PC), a desktop PC, a tablet terminal, a smartphone, and personal digital assistants (PDA). Further, it is also possible to use a video playback device, a DVD (digital versatile disk) player, a Blu-ray (registered trademark) disc player, or a hard disk recorder as the image supply device. Further, a television tuner device, a set-top box for a CATV (cable television), a video gaming machine, or the like can also be used.

The image I/F section 33 is an interface for connecting the image supply device described above, and is provided with a connector, an interface circuit, and so on. To the image I/F section 33, there is input, for example, digital image data with a data format which can be processed by the projector 2. The digital image data can be still image data, or can also be moving image data. The image I/F section 33 can also be provided with a connector and an interface circuit to which a portable storage medium such as a card type storage medium such as an SD (secure digital) memory card, or a USB memory device can be connected.

The configuration of the image I/F section 33 is not limited to a configuration of being connected to the image supply device with wire. It is possible for the image I/F section 33 to have a configuration of, for example, performing wireless data communication such as a wireless LAN (including WiFi (registered trademark), the same applies hereinafter), Miracast (registered trademark), or Bluetooth (registered trademark) with the image supply device.

The wireless communication section 24 (a transmitting section, a receiving section) performs the wireless data communication such as the wireless LAN or Bluetooth with the communication device 11 (FIG. 1).

The sound processing section 25 outputs a sound with the speaker 26 based on digital sound data or an analog sound signal input thereto due to the control by the control section 20.

The position detection section 27 (a detection section) detects the position of the object representing the participant UB in the place where the projector 2 is installed, and defines the position thus detected as the virtual viewing position A1. In the present embodiment, the position detection section 27 detects the projector 4 in the field angle of the camera 271, and determines the position of the projector 4 as the virtual viewing position A1.

The position detection section 27 is provided with the camera 271 (an imaging section), an object detection section 272, and a position calculation section 273. As shown in FIG. 1, the camera 271 is a digital camera capable of imaging the position where the participant UA participates in the use location A. It is more preferable for the camera 271 to be a wide-angle camera, a 360-degree camera, or the like. Further, it is particularly preferable for the camera 271 to be installed so that the place having a possibility of becoming the virtual viewing position A1 is included in the field angle.

The camera 271 performs the imaging at a predetermined timing to output the taken image data.

The object detection section 272 detects the image of the object representing the participant UB from the taken image data of the camera 271. For example, the object detection section 272 detects the image of the projector 4 from the taken image data. The object detection section 272 detects the image of the object from the taken image data using, for example, image feature amount data related to the image of the object to be detected. Here, the image feature amount data can be the data including the feature amount such as the color and the shape of the object.

Further, it is possible for the object detection section 272 to detect an encrypted code such as a bar-code or a two-dimensional code, or other characters or data from the image data taken by the camera 271 to thereby detect the object. On this occasion, if optically readable data such as a code, a character, or a number is attached to an outer surface of the object such as the projector 4, it is possible for the object detection section 272 to detect such data. Here, it is possible for the object detection section 272 to retrieve and then interpret the data detected in the taken image data. Further, it is also possible to adopt a configuration in which the projector 4 has a specific design which can clearly be distinguished from the background of a general room, and in this case, it is possible for the object detection section 272 to promptly detect the image of the projector 4 from the taken image data.

The position calculation section 273 performs a calculation process based on the position of the image detected by the object detection section 272 in the taken image data to obtain the virtual viewing position A1. The position calculation section 273 obtains the virtual viewing position A1 as a relative position to the projector 2 based on the image detected by the object detection section 272, the relative position to the taken image data, and the relative position between the field angle (the imaging range) of the camera 271 and the projector 2. Here, it is possible for the position calculation section 273 to calculate zoom magnification of the camera 271.

Further, the position calculation section 273 outputs the taken image data taken by the camera 271 to the control section 20. The control section 20 stores the taken image data of the camera 271 in the storage section 22 as the taken image data 225.

It should be noted that the configuration of the position detection section 27 is illustrative only, and it is possible to detect the position of the object using, for example, a laser ranging technology or a near field communication technology.

The input processing section 28 is a functional section for receiving an operation by the user.

The operation panel 281 is disposed in, for example, the housing of the projector 2, and is provided with a variety of switches. The input processing section 28 detects an operation of a switch in the operation panel 281, and then outputs control data representing the switch thus operated to the control section 20.

The remote control light receiving section 282 connected to the input processing section 28 receives an infrared signal transmitted by the remote controller 283, and then decodes the signal thus received. The remote controller 283 is provided with a variety of types of switches, and transmits the infrared signal representing the switch thus operated. The remote control light receiving section 282 outputs the data obtained by decoding the signal thus received to the input processing section 28. The input processing section 28 outputs the data input from the remote control light receiving section 282 to the control section 20.

The projection section 30 (the display section) is provided with a light source 301, a light modulation device 302 for modulating the light emitted by the light source 301 to generate the image light, and a projection optical system 303 for projecting the image light modulated by the light modulation device 302 to form the projection image.

The light source 301 is formed of a lamp such as a halogen lamp, a xenon lamp or a super-high pressure mercury lamp, or a solid-state light source such as an LED or a laser source. The light source 301 lights with the electrical power supplied from the light source drive section 35, and emits light toward the light modulation device 302.

The light source drive section 35 supplies the light source 301 with a drive current or a pulse to make the light source 301 emit light. Further, it is also possible for the light source drive section 35 to control the luminance of the light source 301 due to the control by the control section 20.

The light modulation device 302 modulates the light emitted by the light source 301 to generate the image light, and then irradiates the projection optical system 303 with the image light.

The light modulation device 302 is provided with a light modulation element such as a transmissive liquid crystal light valve, a reflective liquid crystal light valve, or a digital mirror device (DMD). To the light modulation element of the light modulation device 302, there is connected a light modulation device drive section 36.

To the light modulation device drive section 36, there is input an image signal of an image to be drawn in the light modulation device 302 from the image processing section 31. The light modulation device drive section 36 drives the light modulation device 302 based on the image signal output by the image processing section 31. The light modulation device drive section 36 drives the light modulation element of the light modulation device 302 to set the grayscales of the respective pixels, and thus draws the image on the light modulation element frame (screen) by frame (screen).

The projection optical system 303 is provided with a lens and a mirror for forming an image of the light thus modulated by the light modulation device 302 on the screen. Further, the projection optical system 303 can also include a variety of types of lenses such as a zoom lens or a focusing lens, or a lens group.

The image processing section 31 obtains image data from an image source selected due to the control by the control section 20, and then performs a variety of types of image processing on the image data thus obtained. For example, the image processing section 31 performs a resolution conversion process for converting the resolution of the image data in accordance with the display resolution of the light modulation device 302. Further, the image processing section 31 performs a geometric correction process for correcting the shape of the image data, a color compensation process for correcting the tone of the image data, and so on. The image processing section 31 generates the image signal for displaying the image data on which the process has been performed, and then outputs the image signal to the light modulation device drive section 36. In the case of performing the image processing, the image processing section 31 develops the image based on the image data obtained from the image source in the frame memory 32, and then performs a variety of processes on the image developed in the frame memory 32.

The I/F section 34 is connected to an external device such as a PC, and transmits and receives a variety of types of data such as control data with the external device. The data communication compliant with, for example, Ethernet (registered trademark), IEEE 1394, or USB (universal serial bus) is performed.

The control section 20 is provided with a processor (not shown) such as a CPU or a microcomputer, and executes a program with the processor to thereby control the sections of the projector 2. The control section 20 can also be provided with a ROM for storing a control program executed by the processor in a nonvolatile manner, and a RAM constituting the work area for the processor.

The control section 20 has a projection control section 201, an operation acquisition section 202, a communication control section 203, and a virtual image generation section 204 as functional blocks for controlling the sections of the projector 2. These functional blocks are realized by the cooperation of the software and the hardware by the processor of the control section 20 executing the programs stored in the storage section 22 or the ROM (not shown).

The storage section 22 is formed of a magnetic storage device, a semiconductor memory device, or other types of nonvolatile storage device. The storage section 22 stores the data to be processed by the control section 20, and the programs to be executed by the CPU of the control section 20.

Further, the storage section 22 stores setting data 221, content data 222, virtual position data 223, virtual sight line data 224, taken image data 225, virtual image data 226, and user data 227.

The setting data 221 includes a variety of setting values (parameters) for determining the operation of the projector 2. The setting data 221 includes, for example, a setting value for the projector 2 to perform the wireless data communication using the wireless communication section 24. Specifically, the setting data 221 can include the network address and the network identification information of the communication device 11, the network addresses, the IDs, the authentication information such as the passwords of the projector 4 and the terminal device 6. Further, the setting data 221 can include data for designating the type or the content of the image processing executed by the image processing section 31, and the parameters used in the image processing.

The content data 222 includes still image data or moving image data which can be selected as the image source. The content data 222 can also include audio data.

The virtual position data 223 is the data representing the virtual viewing position A1, and expresses the virtual viewing position A1 as, for example, a relative position to the reference set in the main body of the projector 2. The virtual position data 223 can include the data representing the relative positional relationship between the projection direction by the projection section 30 and the virtual viewing position A1 besides the data for defining the relative positional relationship between the projector 2 and the virtual viewing position A1. Further, the virtual position data 223 can include the data representing the relative positional relationship between the field angle of the camera 271 and the virtual viewing position A1.

The virtual position data 223 is generated by the virtual image generation section 204 of the control section 20 controlling the position detection section 27, and is stored in the storage section 22. Further, it is also possible for the operation acquisition section 202 to generate the virtual position data 223 representing the virtual viewing position A1 in the case in which the virtual viewing position A1 is designated or input by the operation received by the operation acquisition section 202, and then store the virtual position data 223 in the storage section 22. Further, it is also possible to adopt a configuration of storing data received by the communication control section 203 in the storage section 22 as the virtual position data 223 in the case in which the communication control section 203 has received the data designating the virtual viewing position A1 from another device constituting the display system 1.

The virtual sight line data 224 is the data representing the virtual sight line direction VL. For example, it is possible to adopt a configuration in which the virtual image generation section 204 controls the position detection section 27 to generate the virtual sight line data 224 based on the virtual position data 223, and then stores the virtual sight line data 224 in the storage section 22. Further, it is also possible for the operation acquisition section 202 to generate the virtual sight line data 224 representing the virtual sight line direction VL in the case in which the virtual sight line direction VL is designated or input by the operation received by the operation acquisition section 202, and then store the virtual sight line data 224 in the storage section 22. Further, it is also possible to adopt a configuration of storing data received by the communication control section 203 in the storage section 22 as the virtual sight line data 224 in the case in which the communication control section 203 has received the data designating the virtual sight line direction VL from another device constituting the display system 1.

The taken image data 225 is the taken image data taken by the camera 271. Further, it is also possible to adopt a configuration in which the control section 20 performs a process such as trimming or correction based on the taken image data of the camera 271, and then stores the data thus processed in the storage section 22 as the taken image data 225.

The virtual image data 226 is the image data generated by the virtual image generation section 204, and is the data of the image imitating the case of viewing the image projected by the projection section 30 in accordance with the virtual sight line direction VL.

The user data 227 is the data related to the participant UB, and includes at least one of the image data used as the appearance of the participant UB and the audio data of the participant UB. The storage section 22 can store the image data used as the image of the participant UB in advance as the user data 227. In this case, it is also possible to store at least one of the image data and the audio data input via the image I/F section 33 or the I/F section 34 in accordance with the operation detected by the operation acquisition section 202 as the user data 227.

Further, it is also possible to adopt a configuration of storing the user data 227 in the storage section 22 based on data received in the case in which the communication control section 203 has received at least one of the image data and the audio data from another device constituting the display system 1.

The control section 20 controls the sections including the image processing section 31, the light source drive section 35, and the light modulation device drive section 36 using the projection control section 201 to control the projection of the image by the projector 2. Here, the projection control section 201 controls execution timing, execution conditions, and so on of the process executed by the image processing section 31. Further, the projection control section 201 controls the light source drive section 35 to perform control or the like of the luminance of the light source 301. Further, the projection control section 201 can also select the image source in accordance with the operation obtained by the operation acquisition section 202 or preliminary setting.

The operation acquisition section 202 detects an operation to the projector 2. The operation acquisition section 202 detects an operation by at least one of the operation panel 281 and the remote controller 283 functioning as an input device based on the data input from the input processing section 28.

The communication control section 203 controls the wireless communication section 24 to perform the communication with the communication device 11 (FIG. 1) to perform the data communication with the projector 4 and the terminal device 6.

For example, the communication control section 203 transmits the control data related to the operation of the projector 4 to the projector 4. Specifically, the control data for instructing the start of projection of the user image 4a is transmitted. Further, the communication control section 203 can also transmit the user data 227 to the projector 4 as the data for projecting the user image 4a.

Further, the communication control section 203 can also have a configuration of performing the communication with the terminal device 6, and arbitrarily generating the virtual position data 223, the virtual sight line data 224, the user data 227, and so on based on the data transmitted from the terminal device 6 to store the data in the storage section 22.

The virtual image generation section 204 generates the virtual image data 226 based on the data of the image source, the virtual position data 223, and the virtual sight line data 224. The virtual image data 226 represents an image corresponding to the image of the case of viewing the conference-use image 2a projected by the projector 2 from the virtual sight line direction VL.

The virtual image generation section 204 obtains data (hereinafter referred to as projection image data) of the image (e.g., the conference-use image 2a shown in FIG. 1) to be projected by the projection section 30 from the content data 222 stored in the storage section 22 or the data processed by the image processing section 31.

The virtual image generation section 204 performs the process such as deformation, contraction, or trimming on the projection image data based on the virtual position data 223 and the virtual sight line data 224 to generate the virtual image data 226. For example, the virtual image generation section 204 obtains a visual distance from the virtual viewing position A1 to the conference-use image 2a (the screen SC1) from the virtual position data 223 and the virtual sight line data 224, and then contracts or trims the projection image data so as to correspond to the visual distance thus obtained. Further, the virtual image generation section 204 obtains the angle of the virtual sight line direction VL with respect to the conference-use image 2a based on the virtual sight line data 224, and deforms the projection image data contracted or trimmed so as to correspond to the angle thus obtained.

It is also possible for the virtual image generation section 204 to include a part or the whole of the taken image data 225 in the virtual image data 226. For example, it is also possible for the virtual image generation section 204 to clip out the range corresponding to the conference-use image 2a side of the virtual viewing position A1 in the taken image data 225, and then combine the range with the projection image data thus deformed to form the virtual image data 226. Further, it is also possible for the virtual image generation section 204 to combine the taken image data 225 and the projection image data thus deformed with each other to form the virtual image data 226. Further, it is also possible to use the taken image data 225 as data accompanying the virtual image data 226. Further, the virtual image generating section 204 can use virtual taken image data obtained by deforming or trimming the taken image data of the camera 271 so as to correspond to the virtual sight line direction VL and the virtual viewing position A1 as the taken image data 225. In other words, it is also possible to generate the taken image data 225 representing the sight of the use location A in the case of viewing the use location A in the virtual sight line direction VL from the virtual viewing position A1. In this case, if the conference-use image 2a or a sub-image 2b is displayed on the terminal device 6 based on the taken image data 225, the participant UB can obtain the feeling of presence as if the participant UB were present in the virtual viewing position A1.

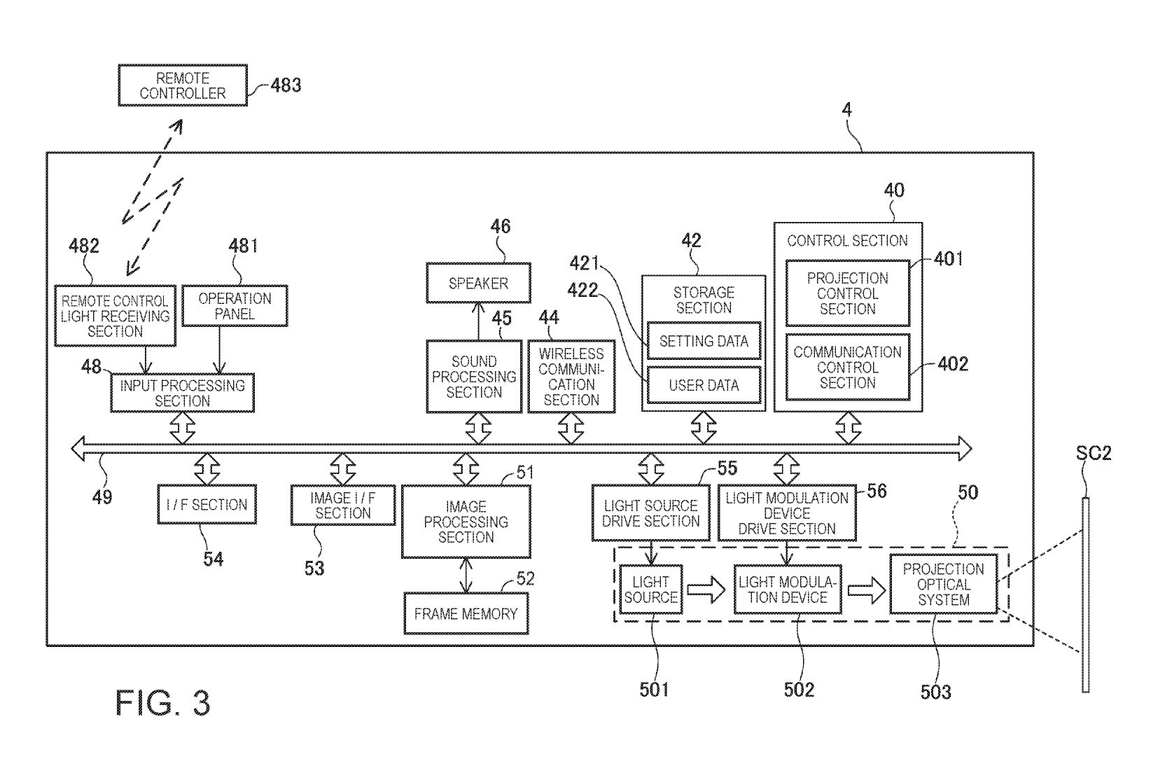

FIG. 3 is a block diagram of the projector 4.

The projector 4 is provided with a control section 40, a storage section 42, a wireless communication section 44, a sound processing section 45, and an input processing section 48. Further, the projector 4 is provided with a projection section 50, an image processing section 51, an image I/F section 53, and an I/F section 54. These sections are connected to each other via a bus 49 so as to communicate with each other. Further, as described later, a speaker 46 is connected to the sound processing section 45, and an operation panel 481 and a remote control light receiving section 482 are connected to the input processing section 48. Further, a frame memory 52 is connected to the image processing section 51.

The projector 4 obtains image data from an image source, and then projects an image based on the image data thus obtained using the projection section 50 due to the control by the control section 40. The function of the control section 40 and a variety of types of data stored by the storage section 42 will be described later.

The image source of the projector 4 can be selected from the image data input to the image I/F section 53, and the image data stored in the storage section 42. The storage section 42 stores contents data 222 described later as the data which can be the image source.

It is possible to connect an image supply device similar to the image supply device which can be connected to the projector 2 to the projector 4 as the image source.

The image I/F 53 is an interface for connecting the image supply device described above, and is provided with a connector, an interface circuit, and so on. To the image I/F section 53, there is input, for example, digital image data with a data format which can be processed by the projector 4. The digital image data can be still image data, or can also be moving image data. The image I/F section 53 can also be provided with a connector and an interface circuit to which a portable storage medium such as a card type storage medium such as an SD memory card, or a USB memory device can be connected.

The configuration of the image I/F section 53 is not limited to a configuration of being connected to the image supply device with wire. It is possible for the image I/F section 53 to have a configuration of, for example, performing wireless data communication such as a wireless LAN, Miracast, or Bluetooth with the image supply device.

The wireless communication section 44 performs the wireless data communication such as the wireless LAN or Bluetooth with the communication device 12 (FIG. 1).

The sound processing section 45 outputs a sound with the speaker 46 based on digital sound data or an analog sound signal input thereto due to the control by the control section 40.

The input processing section 48 is a functional section for receiving an operation by the user.

The operation panel 481 is disposed in, for example, the housing of the projector 4, and is provided with a variety of switches. The input processing section 48 detects an operation of a switch in the operation panel 481, and then outputs control data representing the switch thus operated to the control section 40.

The remote control light receiving section 482 connected to the input processing section 48 receives an infrared signal transmitted by the remote controller 483, and then decodes the signal thus received. The remote controller 483 is provided with a variety of types of switches, and transmits the infrared signal representing the switch thus operated. The remote control light receiving section 482 outputs the data obtained by decoding the signal thus received to the input processing section 48. The input processing section 48 outputs the data input from the remote control light receiving section 482 to the control section 40.

The projection section 50 is provided with a light source 501, a light modulation device 502 for modulating the light emitted by the light source 501 to generate the image light, and a projection optical system 503 for projecting the image light modulated by the light modulation device 502 to form the projection image.

The light source 501 is formed of a lamp such as a halogen lamp, a xenon lamp or a super-high pressure mercury lamp, or a solid-state light source such as an LED or a laser source. The light source 501 lights with the electrical power supplied from the light source drive section 55, and emits light toward the light modulation device 502.

The light source drive section 55 supplies the light source 501 with a drive current or a pulse to make the light source 501 emit light. Further, it is also possible for the light source drive section 55 to control the luminance of the light source 501 due to the control by the control section 40.

The light modulation device 502 modulates the light emitted by the light source 501 to generate the image light, and then irradiates the projection optical system 503 with the image light.

The light modulation device 502 is provided with a light modulation element such as a transmissive liquid crystal light valve, a reflective liquid crystal light valve, or a digital mirror device (DMD). To the light modulation element of the light modulation device 502, there is connected a light modulation device drive section 56.

To the light modulation device drive section 56, there is input an image signal of an image to be drawn in the light modulation device 502 from the image processing section 51. The light modulation device drive section 56 drives the light modulation device 502 based on the image signal output by the image processing section 51. The light modulation device drive section 56 drives the light modulation element of the light modulation device 502 to set the grayscales of the respective pixels, and thus draws the image on the light modulation element frame (screen) by frame (screen).

The projection optical system 503 is provided with a lens and a mirror for forming an image of the light thus modulated by the light modulation device 502 on the screen. Further, the projection optical system 503 can also include a variety of types of lenses such as a zoom lens or a focusing lens, or a lens group.

The image processing section 51 obtains image data from an image source selected due to the control by the control section 40, and then performs a variety of types of image processing on the image data thus obtained. For example, the image processing section 51 performs a resolution conversion process for converting the resolution of the image data in accordance with the display resolution of the light modulation device 502. Further, the image processing section 51 performs a geometric correction process for correcting the shape of the image data, a color compensation process for correcting the tone of the image data, and so on. The image processing section 51 generates the image signal for displaying the image data on which the process has been performed, and then outputs the image signal to the light modulation device drive section 56. In the case of performing the image processing, the image processing section 51 develops the image based on the image data obtained from the image source in the frame memory 52, and then performs a variety of processes on the image developed in the frame memory 52.

The I/F section 54 is connected to an external device such as a PC, and transmits and receives a variety of types of data such as control data with the external device.

The control section 40 is provided with a processor (not shown) such as a CPU or a microcomputer, and executes a program with the processor to thereby control the sections of the projector 4. The control section 40 can also be provided with a ROM for storing a control program executed by the processor in a nonvolatile manner, and a RAM constituting the work area for the processor.

The control section 40 has a projection control section 401 and a communication control section 402 as functional blocks for controlling the sections of the projector 4. These functional blocks are realized by the cooperation of the software and the hardware by the processor of the control section 40 executing the programs stored in the storage section 42 or the ROM (not shown).

The storage section 42 is formed of a magnetic storage device, a semiconductor memory device, or other types of nonvolatile storage device. The storage section 42 stores the data to be processed by the control section 40, and the programs to be executed by the CPU of the control section 40.

Further, the storage section 42 stores setting data 421 and user data 422.

The setting data 421 includes a variety of setting values (parameters) for determining the operation of the projector 4. The setting data 421 includes, for example, a setting value for the projector 4 to perform the wireless data communication using the wireless communication section 44. Specifically, the setting data 421 can include the network address and the network identification information of the communication device 11, the network addresses, the IDs, the authentication information such as the passwords of the projector 2 and the terminal device 6. Further, the setting data 421 can include data for designating the type or the content of the image processing executed by the image processing section 51, and the parameters used in the image processing.

The user data 422 is the data related to the participant UB, and includes at least one of the image data used as the appearance of the participant UB and the audio data of the participant UB. The storage section 42 can store the image data used as the image of the participant UB in advance as the user data 422. In this case, it is also possible to store at least one of the image data and the audio data input via the image I/F section 53 or the I/F section 54 in accordance with the operation detected by the operation acquisition section 202 as the user data 422. Further, it is also possible to adopt a configuration of storing the user data 422 in the storage section 42 based on data received in the case in which the communication control section 402 has received at least one of the image data and the audio data from the projector 2.

The control section 40 performs the operations of the projection control section 401 and the communication control section 402 in accordance with the operation detected based on the data input from the input processing section 48 or the control data transmitted from the projector 2.

The projection control section 401 controls the sections including the image processing section 51, the light source drive section 55, and the light modulation device drive section 56 to control the projection of the image by the projector 4. Here, the projection control section 401 controls execution timing, execution conditions, and so on of the process executed by the image processing section 51. Further, the projection control section 401 controls the light source drive section 55 to perform control or the like of the luminance of the light source 501. Further, the projection control section 401 can also select the image source in accordance with the operation obtained by the operation acquisition section 202 or preliminary setting.

The communication control section 402 controls the wireless communication section 44 to perform the communication with the communication device 11 (FIG. 1) to perform the data communication with the projector 2. Further, it is also possible for the communication control section 402 to perform data communication with the terminal device 6 via the communication device 11.

The communication control section 402 receives the control data transmitted by the projector 2. Specifically, the communication control section 402 receives the control data for instructing the start of projection of the user image 4a. Further, in the case in which the projector 2 transmits the user data 227, the communication control section 402 receives the user data 227, and then stores the user data 227 in the storage section 42 as the user data 422.

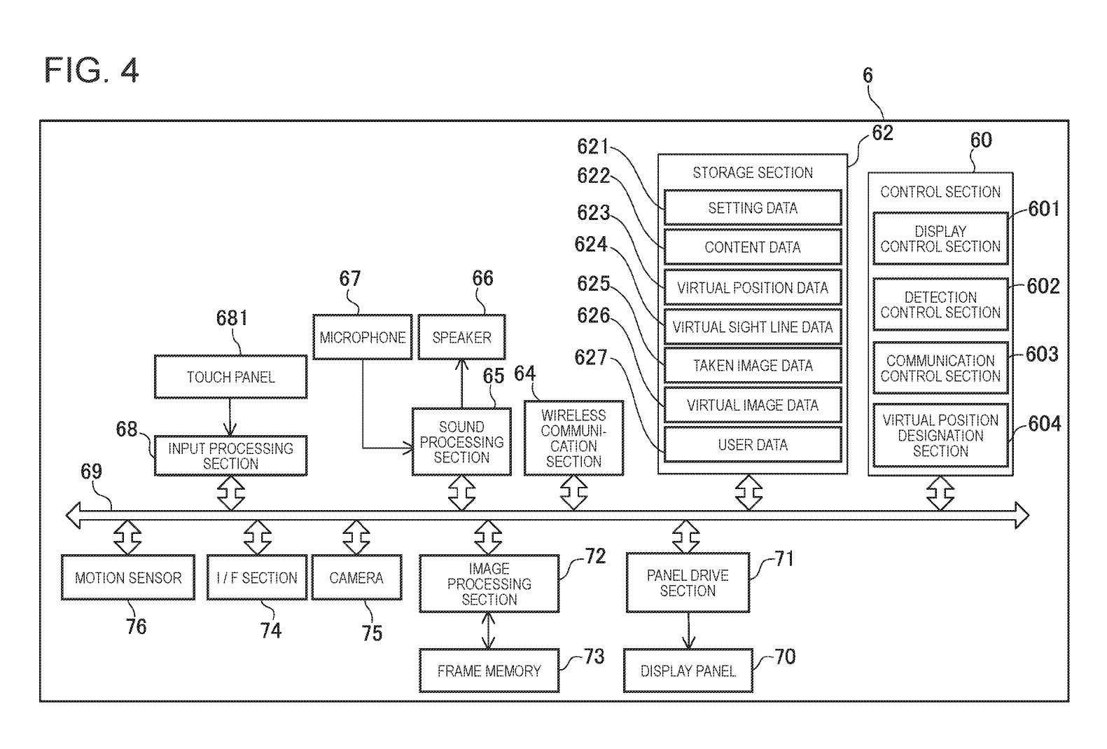

FIG. 4 is a block diagram of the terminal device 6.

The terminal device 6 is provided with a control section 60, a storage section 62, a wireless communication section 64, a sound processing section 65, and an input processing section 68. Further, the terminal device 6 is provided with a display panel 70, an image processing section 72, an I/F section 74, a camera 75, and a motion sensor 76. These sections are connected to each other via a bus 69 so as to communicate with each other. Further, as described later, a speaker 66 and a microphone 67 are connected to the sound processing section 65, and a touch panel 681 is connected to the input processing section 68. Further, a frame memory 73 is connected to the image processing section 72.

The terminal device 6 obtains image data from an image source, and then displays an image based on the image data thus obtained using the display panel 70 due to the control by the control section 60. The function of the control section 60 and a variety of types of data stored by the storage section 62 will be described later.

The image source of the terminal device 6 is, for example, image data stored in the storage section 62, and is specifically content data 622 or virtual image data 626.

The wireless communication section 64 (a second device transmitting section) performs the wireless data communication such as the wireless LAN or Bluetooth with the communication device 12 (FIG. 1). It is also possible to connect a variety of image supply devices (e.g., those described above) capable of communicating using the wireless communication section 64 to the terminal device 6 as the image sources.

The sound processing section 65 outputs a sound with the speaker 66 based on digital sound data or an analog sound signal input thereto due to the control by the control section 60. Further, the sound processing section 65 collects the sound using the microphone 67 to generate digital audio data, and then outputs the digital audio data to the control section 60 due to the control by the control section 60.

As shown in FIG. 1, the terminal device 6 is provided with the display panel 70 disposed on the surface of the housing shaped like a flat plate, and the touch panel 681 is disposed so as to overlap the display panel 70. The touch panel 681 is a pressure-sensitive touch sensor, or a capacitance touch sensor each having a light transmissive property. The input processing section 68 detects a contact operation to the touch panel 681, and then outputs data representing the operation position toe the control section 60.

The display panel 70 is a plate-like display device constituted by a liquid crystal display panel, an organic EL display panel, or the like, and is disposed on a surface of the housing of the terminal device 6 as shown in FIG. 1. The display panel 70 is connected to the panel drive section 71, and is driven by the panel drive section 71 to display a variety of images.

The image processing section 51 drives a display element of the display panel 70 to set the grayscales of the respective pixels, and thus draws the image frame (screen) by frame (screen).

The image processing section 72 obtains image data from the image source selected due to the control by the control section 60, and then performs a variety of types of image processing on the image data thus obtained. For example, the image processing section 72 performs a resolution conversion process for converting the resolution of the image data in accordance with the display resolution of the display panel 70. Further, the image processing section 72 performs a color compensation process for correcting the tone of the image data, and so on. The image processing section 72 generates the image signal for displaying the image data on which the process has been performed, and then outputs the image signal to the panel drive section 71. In the case of performing the image processing, the image processing section 72 develops the image based on the image data obtained from the image source in the frame memory 73, and then performs a variety of processes on the image developed in the frame memory 73.

The I/F section 74 is connected to an external device such as a PC, and transmits and receives a variety of types of data such as control data with the external device.

The motion sensor 76 is a sensor for detecting a motion of the terminal device 6 such as a gyro sensor (an angular velocity sensor) or an acceleration sensor, and outputs the detection value to the control section 60 with a predetermined period. It is possible for the motion sensor 76 to be provided with a geomagnetic sensor to output the detection value related to the posture of the terminal device 6. Further, the specific configuration of the motion sensor 76 is arbitrary, and it is possible to adopt a one-axis sensor, a two-axis sensor, a three-axis sensor, or a three-axis+three-axis composite sensor module. For example, it is preferable that the rotation of the terminal device 6 in the direction indicated by the arrow R in FIG. 1 can be detected. The arrow R shows a direction in which the terminal device 6 is rotated around a virtual axis in the vertical direction in the case of making the terminal device 6 have a posture in which the display panel 70 is parallel to the vertical direction.

The control section 60 is provided with a processor (not shown) such as a CPU or a microcomputer, and executes a program with the processor to thereby control the sections of the terminal device 6. The control section 60 can also be provided with a ROM for storing a control program executed by the processor in a nonvolatile manner, and a RAM constituting the work area for the processor.

The control section 60 has a display control section 601, a detection control section 602, a communication control section 603, and a virtual position designation section 604 as functional blocks for controlling the sections of the terminal device 6. These functional blocks are realized by the cooperation of the software and the hardware by the processor of the control section 60 executing the programs stored in the storage section 62 or the ROM (not shown).

The storage section 62 is formed of a magnetic storage device, a semiconductor memory device, or other types of nonvolatile storage device. The storage section 62 stores the data to be processed by the control section 60, and the programs to be executed by the CPU of the control section 60.

Further, the storage section 62 stores setting data 621, content data 622, virtual position data 623, virtual sight line data 624, taken image data 625, virtual image data 626, and user data 627.

The setting data 621 includes a variety of setting values (parameters) for determining the operation of the terminal device 6. The setting data 621 includes, for example, the setting value for the terminal device 6 to perform the wireless data communication using the wireless communication section 64. Specifically, the setting data 621 can include the network address and the network identification information of the communication device 12, the network addresses, the IDs, the authentication information such as the passwords of the projector 2 and the projector 4. Further, the setting data 621 can include data for designating the type or the content of the image processing executed by the image processing section 72, and the parameters used in the image processing.

The content data 622 includes still image data or moving image data which can be selected as the image source. The content data 622 can also include audio data. The content data 622 does not necessarily coincide with the content data 222 stored by the projector 2.

The virtual position data 623 is the data representing the virtual viewing position A1, and is the data expressing the virtual viewing position A1 as, for example, a relative position to the reference set in the main body of the projector 2 similarly to the virtual position data 223.

In the case of designating the virtual viewing position A1 by the operation in the terminal device 6, the virtual position data 623 is generated by the virtual position designation section 604 due to the operation detected by the input processing section 68. The virtual position data 623 is transmitted to the projector 2 due to the function of the communication control section 603.

The virtual sight line data 624 is the data representing the virtual sight line direction VL. In the case of designating the virtual sight line direction VL by the operation in the terminal device 6, the virtual sight line data 624 is generated by the virtual position designation section 604 due to the operation detected by the input processing section 68. The virtual sight line data 624 is transmitted to the projector 2 due to the function of the communication control section 603.

The taken image data 625 is the taken image data taken by the projector 2 using the camera 271, or the data obtained by processing the taken image data of the camera 271. The taken image data 625 is received by the communication control section 603 from the projector 2, and is then stored in the storage section 62.

The virtual image data 226 is the image data generated by the projector 2, and then received due to the control by the communication control section 603.

The user data 627 is the data related to the participant UB, and includes at least one of the image data used as the appearance of the participant UB and the audio data of the participant UB. The storage section 62 can store the image data used as the image of the participant UB in advance as the user data 627. Further, the user data 627 can also be the data generated based on the taken image data of the camera 75. Further, the user data 627 can also include the digital audio data generated by the sound processing section 65, or can also have a configuration including only the digital audio data.

The display control section 601 provided to the control section 60 controls the sections including the image processing section 72 to make the display panel 70 display the image. Here, the display control section 601 controls execution timing, execution conditions, and so on of the process executed by the image processing section 72.

In the case in which the terminal device 6 communicates with the projector 2 to become in an active state in which the participant UB uses the terminal device 6 for the conference held in the use location A, the display control section 601 makes the display panel 70 display the virtual image 6a. The virtual image 6a is displayed using the virtual image data 626 stored in the storage section 62 as the image source.

The detection control section 602 detects the operation of the touch panel 681 based on the data input from the input processing section 68. Further, the detection control section 602 obtains the detection value of the motion sensor 76, and obtains the changes in the direction and the position of the terminal device 6 based on the detection value thus obtained.

The communication control section 603 controls the wireless communication section 64 to perform the communication with the communication device 12 (FIG. 1) to perform the data communication with the projector 2. The communication control section 603 transmits the virtual position data 623, the virtual sight line data 624, the user data 627, and so on to the projector 2. Further, the communication control section 603 receives the virtual image data transmitted from the projector 2, and then stores the virtual image data in the storage section 62 as the virtual image data 626.

The virtual position designation section 604 performs a process of designating at least one of the virtual viewing position A1 and the virtual sight line direction VL due to the operation of the terminal device 6.

In the case in which the operation of designating the virtual viewing position A1 is performed using the touch panel 681, the virtual position designation section 604 generates the virtual position data 623 representing the virtual viewing position A1 based on the operation content, and then store the virtual position data 623 in the storage section 62.

Further, in the case in which the operation of designating the virtual sight line direction VL is performed using the touch panel 681, the virtual position designation section 604 generates the virtual sight line data 624 representing the virtual sight line direction VL based on the operation content, and then store the virtual sight line data 624 in the storage section 62.

Further, it is possible for the virtual position designation section 604 to obtain the virtual sight line direction VL in accordance with the motion of the terminal device 6. In the case in which the virtual position designation section 604 detects the motion of rotating the terminal device 6 in, for example, the arrow R (FIG. 1) direction from the detection value of the motion sensor 76, the virtual position designation section 604 determines the virtual sight line direction VL based on an amount of the motion. The amount of the motion of the terminal device 6 can be obtained as, for example, an amount of the motion from the reference position.

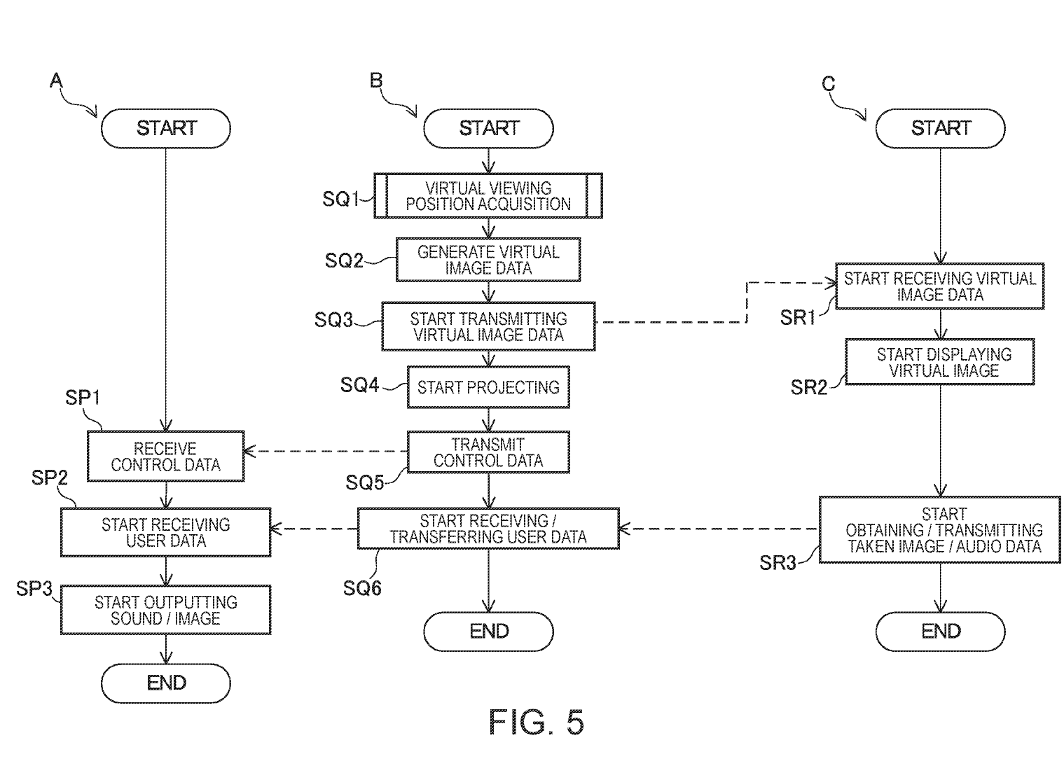

FIG. 5 is a flowchart showing an operation of the display system 1. In FIG. 5, the symbol A represents the operation of the projector 4, the symbol B represents the operation of the projector 2, and the symbol C represents the operation of the terminal device 6.

The operations shown in FIG. 5 represent the operations of the projector 2 and the projector 4 of the display system 1 when starting the operations for having the conference in the state in which the projector 2 and the projector 4 are not projecting the images. Specifically, the operations shown in FIG. 5 are started in the case in which at least one of the projector 2 and the projector 4 is powered ON, the case in which the start of the conference is instructed, or the case in which an app is executed in the terminal device 6, and so on.

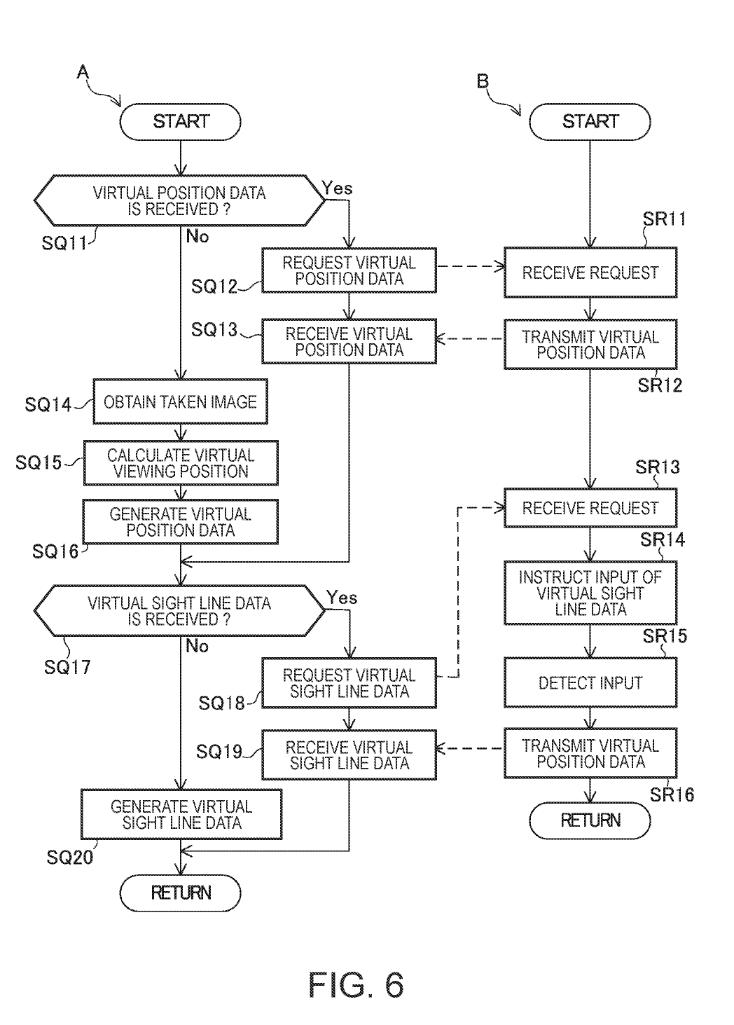

The projector 2 performs (step SQ1) a process of obtaining the virtual viewing position A1 and the virtual sight line direction VL. The details of the process in the step SQ1 will be described later with reference to FIG. 6. As a result of the process in the step SQ1, the projector 2 stores the virtual position data 223 and the virtual sight line data 224 in the storage section 22.

The projector 2 starts (step SQ2) a process of generating the virtual image data 226 based on the virtual position data 223 and the virtual sight line data 224. The projector 2 starts (step SQ3) a process of transmitting the virtual image data 226 thus generated to the terminal device 6. The projector 2 continues the processes started in the steps SQ2, SQ3 until termination of the process is instructed. Further, it is also possible for the projector 2 to start a process of transmitting the taken image data 225 together with the virtual image data 226 in the step SQ3. Further, it is also possible to transmit the taken image data 225 as an inclusion of the virtual image data 226.

The terminal device 6 starts (step SR1) receiving the virtual image data 226 transmitted by the projector 2. The terminal device 6 stores the virtual image data 226 thus received in the storage section 62 as the virtual image data 626, and then starts (step SR2) a process of displaying the virtual image 6a based on the virtual image data 626. Further, it is also possible for the terminal device 6 to start the reception of the taken image data 225 together with the virtual image data 226 in the step SR1 in the case in which the taken image data 225 is transmitted from the projector 2. On this occasion, it is also possible for the terminal device 6 to store the taken image data 225 thus received, and then display the sub-image 2b (FIG. 1) based on the taken image data.

Further, the projector 2 transmits (step SQ5) the control data for starting the projection of the user image 4a based on the user data to the projector 4.

The projector 4 receives (step SP1) the control data transmitted by the projector 2, and then stands ready to receive the user data.

The terminal device 6 obtains the user data 627 including the taken image data of the camera 75 and the audio data of the sound collected by the microphone 67 to generate the user data 627, and then starts (step SR3) a process of transmitting the user data 627 to the projector 2.

The projector 2 starts (step SQ6) a process of receiving the user data 627 transmitted from the terminal device 6, and a process of transmitting the user data 627 thus received. Therefore, the projector 2 receives the user data 627 transmitted by the terminal device 6, and then stores the user data 627 as the user data 227. The projector 2 starts a process of transmitting the user data 227 to the projector 4.

The projector 4 starts (step SP2) the reception of the user data 227 transmitted by the projector 2, and starts (step SP3) the output of the sound and the image based on the user data 227. The projector 4 stores the user data 227 received from the projector 2 as the user data 422. The projector 4 starts a process of outputting the sound from the speaker 46 based on the user data 422, and a process of projecting the user image 4a based on the user data 422.

In FIG. 5, there is described the example in which the projector 4 outputs the user image 4a and the sound based on the user data 422 including the taken image data taken by the terminal device 6 and the audio data collected by the terminal device 6. As described above, in the display system 1, the image prepared in advance can be projected as the user image 4a instead of the taken image data taken by the terminal device 6.

In this case, if adopting, for example, the configuration in which the projector 4 stores the image prepared in advance in the storage section 42, it is sufficient in the step SR3, the step SQ6 and the step SP2 to transmit and receive only the audio data. In the step SP3, the projector 4 outputs the sound based on the audio data thus received, and the user image 4a based on the image data prepared in advance.

Here, in the case of using the image prepared in advance as the user data, it is possible to adopt a configuration in which the projector 2 or the projector 4 prepares a plurality of images, or varies the image prepared in advance. In this case, it is possible for the projector 2 or the projector 4 to vary the image to be displayed as the user data based on the audio data transmitted by the terminal device 6. For example, it is also possible to detect the tone or the variation of the tone from the audio data, estimate the expression and the feelings of the participant UB from the detection result, and then vary the image based on the estimation result. In this case, it is possible to display the user image 4a reflecting the state of the participant UB while using the image prepared in advance.

FIG. 6 is a flowchart showing an operation of the display system 1, and shows the operation in the step SQ1 in FIG. 5 in detail. In FIG. 6, the symbol A represents the operation of the projector 2, and the symbol B represents the operation of the terminal device 6.

The projector 2 stores the virtual position data 223 and the virtual sight line data 224, and these data can be the data generated by the projector 2 detecting the projector 4, or can also be the data provided from an external device.

The projector 2 determines (step SQ11) whether or not the virtual position data is received from the external device (e.g., the terminal device 6). In the case in which it has been determined that the virtual position data is received (Yes in the step SQ11) based on the content set in advance, the projector 2 requests (step SQ12) the virtual position data from the terminal device 6.

When the terminal device 6 receives (step SR11) the request from the projector 2, the terminal device 6 transmits (step SR12) the virtual position data 623 stored in the terminal device 6.

The projector 2 receives the virtual position data 623 transmitted by the terminal device 6 to store (step SQ13) the virtual position data 623 as the virtual position data 223, and then makes the transition to the step SQ17.

In contrast, in the case in which it has been determined that the virtual position data is not received (No in the step SQ11), the projector 2 generates the virtual position data 223 due to the function of the position detection section 27. Specifically, the projector obtains (step SQ14) the taken image data of the camera 271, calculates (step SQ15) the virtual viewing position A1 based on the taken image data, generates (step SQ16) the virtual position data 223 of the position thus calculated, and then stores the virtual position data 223 in the storage section 22. Subsequently, the projector 2 makes the transition to the step SQ17.

In the step SQ17, the projector 2 determines (step SQ17) whether or not the virtual sight line data is received from the external device (e.g., the terminal device 6). In the case in which it has been determined that the virtual sight line data is received (Yes in the step SQ17) based on the content set in advance, the projector 2 requests (step SQ18) the virtual sight line data from the terminal device 6.

When the terminal device 6 receives (step SR13) the request from the projector 2, the terminal device 6 performs (step SR14) display of guiding the input of the virtual sight line direction VL on the display panel 70. Thus, the user (the participant UB) using the terminal device 6 is prompted to input the virtual sight line direction VL. In the step SR14, it is possible for the terminal device 6 to display the user interface for inputting the virtual sight line direction VL on the display panel 70. Further, in order to identify the virtual sight line direction VL using the detection value of the motion sensor 76, it is possible to display the image for instructing the user to move the terminal device 6 on the display panel 70.

The terminal device 6 detects (step SR15) the input operation of the touch panel 681, identifies the virtual sight line direction VL due to the input content, and then generate the corresponding virtual sight line data 624. The terminal device 6 transmits (step SR16) the virtual sight line data 624 thus generated to the projector 2, and then returns to the process shown in FIG. 5. Here, it is also possible for the terminal device 6 to identify the virtual sight line direction VL based on the detection value of the motion sensor 76.

The projector 2 receives the virtual sight line data 624 transmitted by the terminal device 6 to store (step SQ19) the virtual sight line data 624 as the virtual sight line data 224, and then returns to the process shown in FIG. 5.

In contrast, in the case in which it has been determined that the virtual sight line data is not received (No in the step SQ17), the projector 2 generates (step SQ20) the virtual sight line data 224 based on the virtual position data 223 stored in the storage section 22, and then returns to the process shown in FIG. 5.

As described above, in the case of holding the conference using the projector 2 in the use location A, it is possible for the display system 1 to make the participant UB present in the use location B where the conference-use image 2a cannot be viewed remotely participate in the conference. It is possible to provide the production rich in the feeling of presence to both of the participant UA and the participant UB.

To the participant UA, it is possible to show the position of the participant UB not present in the use location A with the projector 4 and the user image 4a. In the use location A, the projector 4 or the user image 4a functions as, so to speak, an alternate (which can also be called a symbol or an icon) for the participant UB. Therefore, it is possible to make the participant UA recognize the presence of the participant UB in a manner of having the feeling of presence. Further, by the projector 4 outputting the sound collected by the terminal device 6, the participant UB actively participates in the conference, and at the same time, the sound of the participant UB is output from the virtual viewing position A1. Therefore, the feeling of presence can further be produced.

To the participant UB, there can be displayed the conference-use image 2a as the virtual image 6a in the terminal device 6 in the state of the case of viewing the conference-use image 2a from the virtual viewing position A1. Therefore, it is possible to make the participant UB recognize the view field of the case of participating in the conference from the position similar to the participant UA in the use location A, and the production rich in the feeling of presence can be produced. Further, by displaying the image showing the appearance in the use location A on the display panel 70 as the sub-image 6b based on the taken image data of the camera 271, it is possible to know the appearance of the use location A in detail, and the feeling of presence can further be produced.

As described hereinabove, the display system 1 according to the present embodiment is provided with the projector 2 for displaying the conference-use image 2a. The display system 1 is provided with the storage section 22 for storing the relative position between the virtual viewing position A1 set in advance to the projector 2 and the projector 2. Further, the display system 1 is provided with the virtual image generation section 204 for generating the virtual image data 226 corresponding to the image obtained by viewing the conference-use image 2a displayed by the projector 2 from the virtual viewing position A1. Further, the display system 1 is provided with the transmitting device for transmitting the virtual image data 226 generated by the virtual image generation section 204, and the terminal device 6 for displaying the virtual image 6a based on the virtual image data 226 transmitted from the transmitting device.

In the present embodiment, as an example, there is cited the configuration in which the projector 2 is provided with the storage section 22 and the virtual image generation section 204. Further, in the present embodiment, there is described the example in which the projector 2 functions as the transmitting device.

According to the display system 1 to which the display system and the method of controlling the display system related to the invention are applied, the image displayed in the terminal device 6 corresponds to the image obtained by viewing the conference-use image 2a displayed by the projector 2 from the virtual viewing position A1. Therefore, it becomes possible for the participant UB present in the place where the projector 2 cannot directly be viewed or the place where it is difficult to view the projector 2 to have an experience as if the participant UB viewed the projector 2 from the virtual viewing position A1 using the terminal device 6. Therefore, in the case of holding a conference in which the plurality of participants (users) participates, the experience rich in the feeling of presence can be provided regardless of whether the location of the participant is the place where the projector 2 can directly be viewed, or the place where it is difficult to view the projector 2.

In other expression, the display system 1 is provided with the projector 2 installed in the use location A as the first site, and displaying the conference-use image 2a, and the storage section 22 for storing the virtual viewing position A1 set in advance to the projector 2 in the use location A. The display system 1 is provided with the virtual image generation section 204 for generating the virtual image data 226 corresponding to the image obtained by viewing the conference-use image 2a displayed by the projector 2 from the virtual viewing position A1. The display system 1 is provided with the transmitting device for transmitting the virtual image data 226 generated by the virtual image generation section 204, and the terminal device 6 disposed in the use location B as the second site, and for displaying the virtual image 6a based on the virtual image data 226 transmitted from the transmitting device.

According to the display system 1 to which the display system and the method of controlling the display system related to the invention are applied, in the case of holding the conference in which the plurality of participants participates, it is possible to provide the experience rich in the feeling of presence to the participant UA present in the use location A where the projector 2 is installed. Further, it is possible to provide the experience rich in the feeling of presence also to the participant UB not present in the use location A.

Further, the display system 1 has the projector 4 as an object to be disposed at the position corresponding to the virtual viewing position A1. Thus, it is possible to make the participant UA present in the position where the projector 2 can be viewed feel the presence of the participant UB using the image of the terminal device 6, and it is possible to provide the experience rich in the feeling of presence to a larger number of participants.

Further, the projector 2 as the transmitting device is provided with the position detection section 27 for detecting the position of the projector 4. The projector 2 stores the position of the projector 4 detected by the position detection section 27 in the storage section 22 as the virtual viewing position A1. Thus, since the position of the object is stored as the virtual viewing position A1, the virtual viewing position A1 corresponding to the position of the object can easily be set.

Further, in the case in which the position of the projector is designated, the projector 2 stores the position of the projector 4 thus designated in the storage section 22 as the virtual viewing position A1. Thus, in the case in which the position of the projector 4 is designated, the virtual viewing position A1 corresponding to the position thus designated can easily be set.

Further, the virtual image generation section 204 generates the virtual image data 226 based on the relative position between the projector 2 and the virtual viewing position A1, and the virtual position data 223 representing the conference-use image 2a. Thus, it is possible to generate the virtual image data 226 of the virtual image 6a accurately corresponding to the image obtained by viewing the conference-use image 2a from the virtual viewing position A1.

Further, the projector 2 is provided with the wireless communication section 24 for transmitting the virtual taken image data generated by the virtual image generation section 204 to the terminal device 6, and the camera 271 for imaging at least a part of the viewing space where the image displayed by the projector 2 can be viewed. The virtual image generation section 204 generates the virtual taken image data corresponding to the image obtained by viewing the viewing space from the virtual viewing position A1. Thus, it becomes possible to display the image corresponding to the sight obtained by viewing the viewing space from the virtual viewing position A1 by the terminal device 6. Therefore, it is possible to provide the viewing experience rich in the feeling of presence as if the participant UB were present in the viewing space to the participant UB located in the position where the projector 2 cannot be viewed or it is difficult to view the projector 2.

Further, in the case in which the virtual sight line direction VL based on the virtual viewing position A1 is designated, the virtual image generation section 204 generates the virtual taken image data corresponding to the case of viewing the virtual sight line direction VL from the virtual viewing position A1. Thus, it is possible to provide the viewing experience rich in the feeling of presence as if the participant UB viewed the viewing space and the display image of the projector 2 from the virtual viewing position A1 to the participant UB located in the position where the projector 2 cannot be viewed or it is difficult to view the projector 2.

Further, the terminal device 6 is provided with the wireless communication section 64 for transmitting the virtual sight line data for designating the virtual sight line direction VL. The wireless communication section 24 of the projector 2 as the transmitting device functions as a receiving section for receiving the virtual sight line data transmitted by the terminal device 6. It is possible for the virtual image generation section 204 to generate the virtual taken image data based on the virtual sight line data received by the wireless communication section 24. In this case, the virtual sight line direction VL can be designated in accordance with the sight line or the operation of the participant UB present in the place where the terminal device 6 is used or the vicinity of the place. Therefore, it is possible to provide the viewing experience richer in feeling of presence to the participant UB located in the position where the projector 2 cannot be viewed or it is difficult to view the projector 2.

Further, the transmitting device is the projector 2. Thus, by the projector 2 transmitting the virtual image data 226, it is possible to simplify the configuration of the system.

Further, the projector 2 to which the display device according to the invention is applied is a display device provided with the projection section 30 for displaying the conference-use image 2a based on the virtual position data 223. The projector 2 is provided with the storage section 22 for storing the relative position between the virtual viewing position A1 set in advance to the projector 2 and the projector 2. The projector 2 is provided with the virtual image generation section 204 for generating the virtual image data 226 corresponding to the image obtained by viewing the image displayed by the projection section 30 from the virtual viewing position A1. The projector 2 is provided with the wireless communication section 24 for transmitting the virtual image data 226 generated by the virtual image generation section 204 to the terminal device 6 as the external display device.

Thus, it is possible for the terminal device 6 to perform display based on the virtual image data 226 corresponding to the image obtained by viewing the conference-use image 2a displayed by the projector 2 from the virtual viewing position A1. Therefore, it becomes possible for the participant UB present in the place where the projector 2 cannot directly be viewed or the place where it is difficult to view the projector 2 to have an experience as if the participant UB viewed the conference-use image 2a from the virtual viewing position A1 using the terminal device 6. Therefore, in the case of holding a conference in which the plurality of participants participates, the experience rich in the feeling of presence can be provided regardless of whether the location of the participant is the place where the conference-use image 2a can directly be viewed, or the place where it is difficult to view the conference-use image 2a.

Further, the terminal device 6 is provided with the motion sensor 76, determines the virtual sight line direction VL based on the amount of the motion or the motion of the terminal device 6 obtained from the detection value of the motion sensor 76, and then transmits the virtual sight line data to the projector 2. Therefore, it is possible for the participant UB to designate the virtual sight line direction VL by moving the terminal device 6. The projector 2 transmits the virtual image data corresponding to the virtual sight line direction VL, and the taken image data of the camera 271 to the terminal device 6. Therefore, it is possible for the participant UB to view the conference-use image 2a and the sight of the use location A as if the participant UA present in the use location A moves the sight line. Therefore, it is possible to obtain a stronger feeling of presence.

In the first embodiment described above, there is illustrated the configuration in which the projector 2 also functions as the transmitting device, but it is also possible to, for example, dispose the transmitting device as a separate body from the projector 2. Further, in the first embodiment described above, there is adopted the configuration in which the projector 4 installed so as to correspond to the virtual viewing position A1 has the function of projecting (displaying) the user image 4a, and the function of outputting the sound, but it is also possible to adopt a configuration not provided with these functions. This example will be described below as a second embodiment.

### Second Embodiment

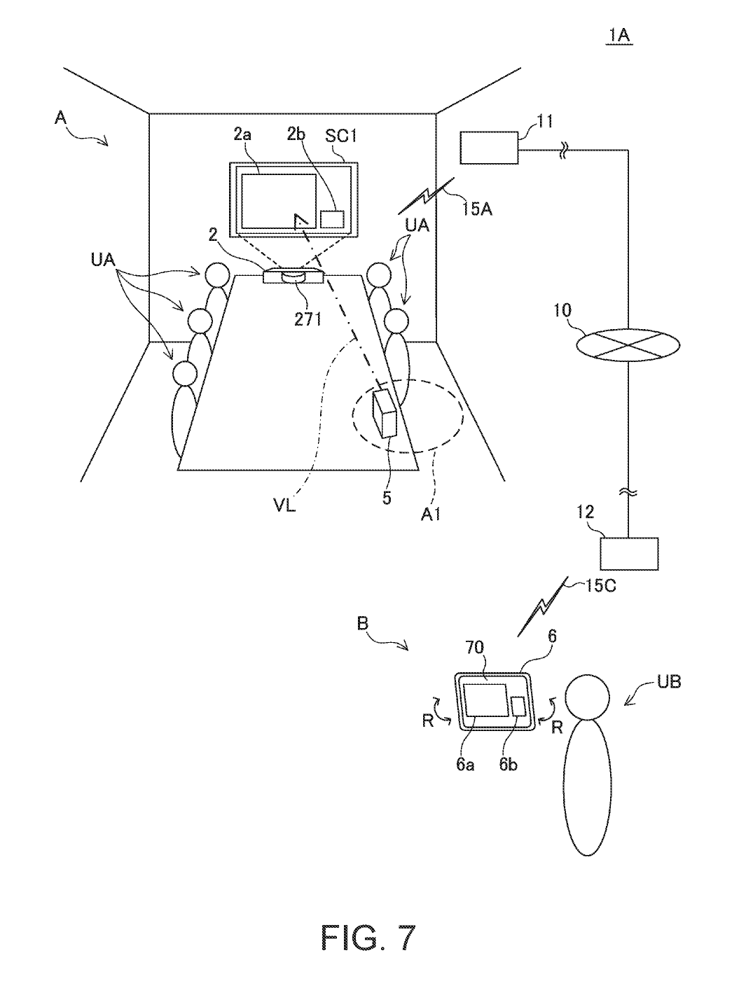

FIG. 7 is a schematic configuration diagram of a display system 1A according to the second embodiment of the invention. Similarly to the display system 1, the display system 1A is a system for realizing the conference by the participant UA present in the use location A and the participant UB present in the use location B.

In the second embodiment, the constituents common to the first embodiment described above will be denoted by the same reference symbols, and the description thereof will be omitted.

The display system 1A has a configuration of installing an object 5 in the use location A instead of the projector 4 provided to the display system 1. The object 5 is used as a substance for visually presenting the virtual viewing position A1 to the participant UA. The object 5 is only required to be visually recognizable for the participant UA, and the shape, the material, the color, and other attributes are no object, and can also be paper, a sticker, or a drawing attached to or mounted on the desk or the wall surface. The object 5 is not required to have the functions such as the communication function with the communication device 11 and the output function of an image and a sound.

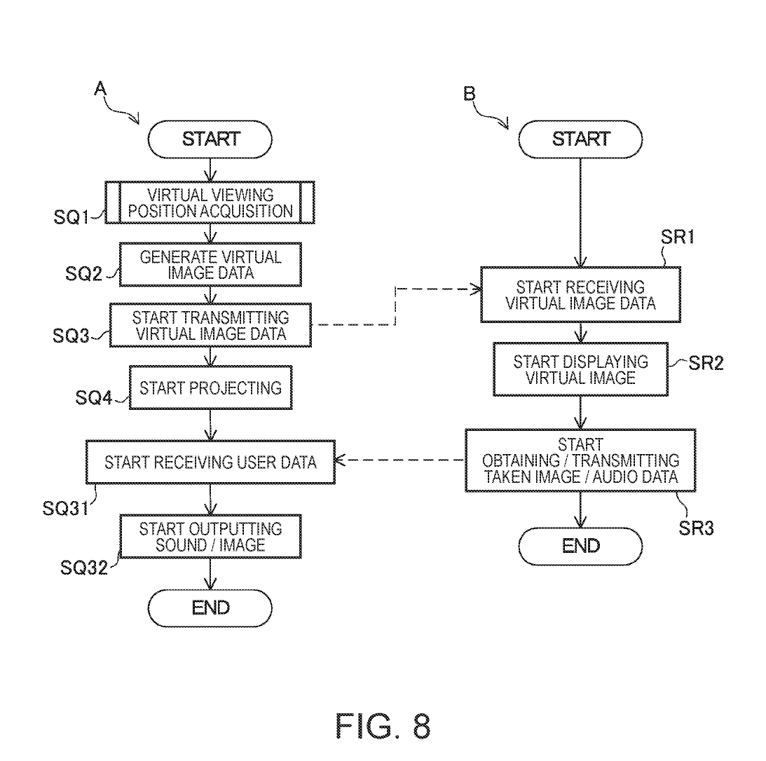

FIG. 8 is a flowchart showing an operation of the display system 1A. In FIG. 8, the symbol A represents the operation of the projector 2, and the symbol B represents the operation of the terminal device 6.

The operations shown in FIG. 8 correspond to the operations shown in FIG. 5 in the first embodiment. FIG. 8 shows the operations when starting the operations for having the conference in the state in which the projector 2 of the display system 1A is not projecting an image. Specifically, the operations shown in FIG. 8 are started in the case in which the projector 2 is powered ON, the case in which the start of the conference is instructed, or the case in which an app is executed in the terminal device 6, and so on. Further, in the operations shown in FIG. 8, the processes common to those shown in FIG. 5 are denoted by the same step numbers, and the description thereof will be omitted.

In the step SQ1 shown in FIG. 8, the process of the projector 2 obtaining the virtual viewing position A1 can be performed as substantially the same process as shown in FIG. 6 if using the object 5 instead of the projector 4.

In the processes shown in FIG. 8, when the terminal device 6 starts (step SR3) the process of transmitting the user data 627 to the projector 2, projector 2 starts (step SQ31) the process of receiving the user data 627 transmitted from the terminal device 6. The projector 2 stores the user data 627 thus received as the user data 227, and then starts (step SQ32) a process of outputting the image and the sound based on the user data 227. In the step SQ32, the projector 2 projects (displays) the sub-image 2b based on the user data 227. As shown in FIG. 7, the sub-image 2b is an image displayed together with the conference-use image 2a in the screen SC1, and is displayed based on the user data related to the participant UB. The sub-image 2b is an image based on the image data prepared in advance or the taken image data taken by the terminal device 6.

Further, the projector 2 outputs the sound from the speaker 26 based on the user data 227.

As described above, the display system 1A according to the second embodiment is capable of realizing the conference rich in the feeling of presence similarly to the display system 1 in the configuration of installing the object 5 not provided with the functions such as the sound output or the image display instead of the projector 4.

It should be noted that the embodiments described above are nothing more than examples of a specific aspect to which the invention is applied, and therefore, do not limit the invention. Therefore, it is also possible to implement the invention as different aspects. For example, in the embodiments described above, the projector 2, the projector 4 and the terminal device 6 are illustrated as the display devices. The invention is not limited to the above, but it is possible to use, for example, a display device provided with a display surface for displaying the conference-use image 2a instead of the projector 2. Further, it is possible to use a display device provided with a display surface for displaying the user image 4a instead of the projector 4. These display devices each can be formed of a device having a liquid crystal display panel or an organic EL display panel, or can also be a device installed on the wall surface, the ceiling surface, or the desktop in the use location A. Further, it is possible to use a variety of types of devices having a display screen such as a notebook computer or a desktop computer instead of the terminal device 6. Further, it is possible to configure the terminal device 6 as a projector for projecting the virtual image 6a and the sub-image 6b on a screen.

Further, the participants having the conference using the display system 1 or the display system 1A are not limited to the combination of the plurality of participants UA and a single participant UB. For example, the participants UA in the use location A can be single, or larger in number, and the same applies to the participant UB. Further, the positional relationship between the participants UA and the participant UB and the virtual viewing position A1 is not limited. It is also possible to set a plurality of virtual viewing positions A1 in the use location A so as to correspond to the number of the participants UB, or to set only a small number of virtual viewing points A1 corresponding to some of the participants UB.

Further, the terminal device 6 can be provided with a configuration provided only with the microphone. In this case, it is sufficient to adopt a configuration in which an image prepared in advance is used as the user image 4a, and the user data including the audio data is transmitted from the terminal device 6 to the projector 2.

Further, the terminal device 6 can update the virtual sight line direction VL following the variation of the detection value of the motion sensor 76, or can transmit the virtual sight line data representing the virtual sight line direction VL thus updated to the projector 2. It is sufficient for the projector 2 to update the virtual image data and then transmit the virtual image data to the terminal device 6 every time the virtual sight line data is updated. According to this configuration, since the virtual image varies so as to follow the motion of the terminal device 6, a stronger feeling of presence can be produced.

Further, it is also possible for the participant UB to use a head-mounted display (HMD) instead of the terminal device 6 described in each of the embodiments described above. The HMD can be provided with the configuration in which the display device having substantially the same shape as the terminal device 6 is mounted on the head using a jig, or can be a dedicated device to be mounted on the head. Further, it is also possible to adopt a configuration in which the participant UB can view only the image displayed by the HMD, or it is also possible to adopt a so-called see-through type HMD in which the participant UB can view the background transmitted through the HMD together with the display image. The constituents provided to the HMD can be made substantially the same as, for example, the functional blocks of the terminal device 6 shown in FIG. 4.

In this case, it is possible to adopt a configuration in which, for example, the conference-use image 2a can be viewed instead of the virtual image based on the virtual sight line direction VL when the HMD is located in the predetermined direction or at the initial position. Further, in the case in which the motion is detected by the motion sensor 76 of the HMD due to the participant UB moving the head, the virtual sight line direction VL changes in accordance with the motion, and it is possible to transmit the virtual image based on the virtual sight line direction VL thus changed from the projector 2 to the HMD. Further, it is also possible to generate the virtual image from the taken image of the camera 271 to transmit the virtual image thus generated from the projector 2 to the HMD. Further, the HMD can update the virtual sight line direction VL following the motion of the HMD, or can transmit the virtual sight line data representing the virtual sight line direction VL thus updated to the projector 2. It is sufficient for the projector 2 to update the virtual image data and then transmit the virtual image data to the HMD every time the virtual sight line data is updated. Thus, it is possible for the participant UB to obtain the feeling of presence as if the participant UB participated in the conference at the position adjacent to the participant UA in the use location A. Further, it is not easy for the HMD to take an image of the participant UB wearing the HMD, but in this case, it is possible to use an image prepared in advance as the user data including the image of the participant UB.

Further, at least a part of the functional blocks shown in the block diagrams can be realized using hardware, or can be provided with a configuration realized by cooperation of the hardware and the software, and the invention is not limited to the configuration of arranging the independent hardware resources in the same manner as shown in the drawings.

Further, the programs executed by the control section can also be stored in the storage section or other storage devices (not shown). Further, it is possible to adopt a configuration in which the control section retrieves and then executes the program stored in an external device.

Further, the invention can also be constituted by programs executed by a computer for realizing the method of controlling the display system 1, 1A or the projectors 2, 4 and the terminal device 6. Further, the invention can also be configured as an aspect of a recording medium storing these programs in a computer readable manner, or a transmission medium for transmitting the programs. As the recording medium described above, there can be used a magnetic or optical recording device, or a semiconductor memory device. Further, the recording medium described above can also be a nonvolatile storage device such as a RAM, a ROM, or an HDD as an internal storage device provided to the devices provided to the display system 1, 1A, or the internal storage device provided to external devices connected to such devices.

Besides the above, the specific detailed configuration of each of the other sections of equipment constituting the display system 1, 1A can arbitrarily be modified within the scope or the spirit of the invention.

The entire disclosure of Japanese Patent Application No. 2017-115811, filed Jun. 13, 2017 is expressly incorporated by reference herein.

What is claimed is:

1. A display system comprising:
a first display device adapted to display an original image;
a storage section adapted to store a relative position between a virtual viewing position set in advance to the first display device and the first display device;
a virtual image generation section adapted to generate virtual image data corresponding to an image obtained by viewing the original image displayed by the first display device from the virtual viewing position;
a transmitting device adapted to transmit the virtual image data generated by the virtual image generation section; and
a second display device adapted to display the virtual image based on the virtual image data transmitted by the transmitting device.

2. The display system according to claim 1, further comprising:
an object disposed at a position corresponding to the virtual viewing position.

3. The display system according to claim 2, wherein
the transmitting device is provided with a detection section adapted to detect a position of the object, and
the storage section stores the position of the object detected by the detection section as the virtual viewing position.

4. The display system according to claim 2, wherein
in a case in which the position of the object is designated, the transmitting device stores the position of the object designated in the storage section as the virtual viewing position.

5. The display system according to claim 1, wherein
the transmitting device includes
a transmitting section adapted to transmit the virtual taken image data generated by the virtual image generation section to the second display device, and
an imaging section adapted to image at least a part of a viewing space where an image displayed by the first display device can be viewed, and
the virtual image generation section generates virtual taken image data corresponding to an image obtained by viewing the viewing space from the virtual viewing position.

6. The display system according to claim 5, wherein
in a case in which a virtual sight line direction based on the virtual viewing position is designated, the virtual image generation section generates the virtual taken image data corresponding to a case of viewing the virtual sight line direction from the virtual viewing position.

7. The display system according to claim 6, wherein
the second display device is provided with a second device transmitting section adapted to transmit virtual sight line data adapted to designate the virtual sight line direction,
the transmitting device is provided with a reception section adapted to receive the virtual sight line data transmitted from the second display device, and
the virtual image generation section generates the virtual taken image data based on the virtual sight line data received by the reception section.

8. The display system according to claim 1, wherein
the transmitting device is the first display device.

9. A display device equipped with a display section adapted to display an original image based on original image data, comprising:
a storage section adapted to store a relative position between a virtual viewing position set in advance to the display device and the display device;
a virtual image generation section adapted to generate virtual image data corresponding to an image obtained by viewing an image displayed by the display section from the virtual viewing position; and
a transmitting section adapted to transmit the virtual image data generated by the virtual image generation section to an external display device.

10. A method of controlling a display system provided with a first display device adapted to display an original image, and a second display device, the method comprising:
generating virtual image data corresponding to an image obtained by viewing the original image displayed by the first display device from the virtual viewing position based on a relative position between a virtual viewing position set in advance to the first display device and the first display device;
transmitting the virtual image data generated to the second display device; and
displaying, by the second display device, the virtual image based on the virtual image data.
